(19) United States
(12) Patent Application Publication
(10) Pub. No.: US 2012/0105503 A1
(43) Pub. Date: May 3, 2012

(54) ILLUMINATION DEVICE AND LIQUID CRYSTAL DISPLAY DEVICE

(75) Inventors: Tomoyuki TADA, Kanagawa-ken (JP); Naotada Okada, Kanagawa-ken (JP); Toshitake Kitagawa, Kanagawa-ken (JP); Ryosuke Nonaka, Kanagawa-ken (JP); Masahiro Baba, Kanagawa-ken (JP); Go Ito, Tokyo (JP)

(73) Assignee: KABUSHIKI KAISHA TOSHIBA, Tokyo (JP)

(21) Appl. No.: 13/285,303

(22) Filed: Oct. 31, 2011

(30) Foreign Application Priority Data
Nov. 2, 2010 (JP) 2010-246752

(51) Int. Cl. G09G 5/10; G02F 1/13357; G09G 3/36; F21V 8/00

(52) U.S. Cl. 345/690; 362/613; 349/65; 345/87

(57) ABSTRACT

According to one embodiment, an illumination device includes a light guide plate and a plurality of light sources. The light guide plate includes a light emitting surface. The plurality of light sources whose light emission luminance can be controlled individually, the light sources being configured to supply light from an edge portion of the light guide plate into the light guide plate. A luminance distribution of light injected from the light sources into the light guide plate and emitted from the light emitting surface is obtained by a function such that relative intensity relative to a DC component in a spatial frequency region is less than or equal to a first threshold in a spatial frequency region having a value of one or more. Source-to-source distance of the light sources is optimized by the luminance distribution of the light.

### CROSS-REFERENCE TO RELATED APPLICATIONS

This application is based upon and claims the benefit of priority from the prior Japanese Patent Application No. 2010-246752, filed on Nov. 2, 2010; the entire contents of which are incorporated herein by reference.

### FIELD

Embodiments described herein relate generally to an illumination device and a liquid crystal display device.

### BACKGROUND

Recently, liquid crystal display (hereinafter also referred to as LCD) devices have rapidly become widespread as thin display devices. However, LCD devices have the problem of lower contrast as compared with CRT (cathode-ray tube) display devices.

On the other hand, in a direct-type backlight device, for instance, light is emitted from a light source disposed directly below a light guide plate. In the direct-type backlight device, local dimming is performed. Local dimming is to partially control the luminance of the backlight device based on the brightness of the display image. This can enhance the contrast. However, in an edge light-type backlight device, for instance, light from a light source disposed at the edge portion of a light guide plate is emitted in a planar configuration by the light guide plate. In the edge light-type backlight device, the light from the light source is spread while propagating in the light guide plate. This makes it difficult to partially light the light guide plate to partially control the luminance of the backlight device. That is, in the edge light-type backlight device, there is room for improvement in enhancing the effect of local dimming.

### BRIEF DESCRIPTION OF THE DRAWINGS

FIG. 1 is a schematic plan view showing an illumination device according to an embodiment of the invention;

FIGS. 2A and 2B are enlarged schematic views of the illumination device according to this embodiment as viewed from the direction of arrow A1 shown in FIG. 1;

FIGS. 3A and 3B are schematic views illustrating the simulation results for the luminance distribution of the illumination device;

FIG. 4 is a block diagram showing the main configuration of a liquid crystal display device according to this embodiment;

FIG. 5 is a schematic plan view illustrating an image displayed on the liquid crystal panel;

FIGS. 6A and 6B are schematic plan views showing the lighting state of the light sources;

FIG. 7 is a graph comparing the power consumption;

FIG. 8 is a graph comparing the luminance at positions P1-P1 shown in FIG. 5;

FIG. 9 is a graph for describing the ideal luminance distribution;

FIGS. 10A and 10B are graphs illustrating a light emission luminance distribution of the light sources of this embodiment;

FIGS. 11A to 11F are graphs for describing the relationship between the shape of the luminance distribution of the light sources of this embodiment and the spatial frequency component thereof;

FIGS. 12A and 12B are graphs illustrating another light emission luminance distribution of the light sources of this embodiment;

FIGS. 13A and 13B are graphs illustrating still another light emission luminance distribution of the light sources of this embodiment;

FIGS. 14A to 14F are graphs illustrating the relationship between the light sources and the luminance distribution;

FIG. 15 is a graph illustrating the relationship between the ideal luminance distribution and the source-to-source distance;

FIG. 16 is a graph for describing the optimization of the source-to-source distance;

FIG. 17 is a graph illustrating the optimized source-to-source distance;

FIG. 18 is a graph showing the relationship between the vertex angle of the groove of the light guide plate of this embodiment and the lighting area width;

FIG. 19 is a graph showing the relationship between the depth of the groove of the light guide plate of this embodiment and the lighting area width; and

FIG. 20 is a graph showing the relationship between the distance from the light incident end of the light guide plate of this embodiment and the lighting area width.

### DETAILED DESCRIPTION

In general, according to one embodiment, an illumination device includes a light guide plate and a plurality of light sources. The light guide plate includes a light emitting surface at which a plurality of grooves extending in a first direction are formed. The plurality of light sources whose light emission luminance can be controlled individually, the light sources being configured to supply light from an edge portion of the light guide plate into the light guide plate, the edge portion being perpendicular to the first direction. A luminance distribution of light injected from the light sources into the light guide plate and emitted from the light emitting surface is obtained by a function such that relative intensity relative to a DC component in a spatial frequency region is less than or equal to a first threshold in a spatial frequency region having a value of one or more. Source-to-source distance of the light sources is optimized by the luminance distribution of the light.

Embodiments of the invention will now be described with reference to the drawings. In the drawings, similar components are labeled with like reference numerals, and the detailed description thereof is omitted as appropriate.

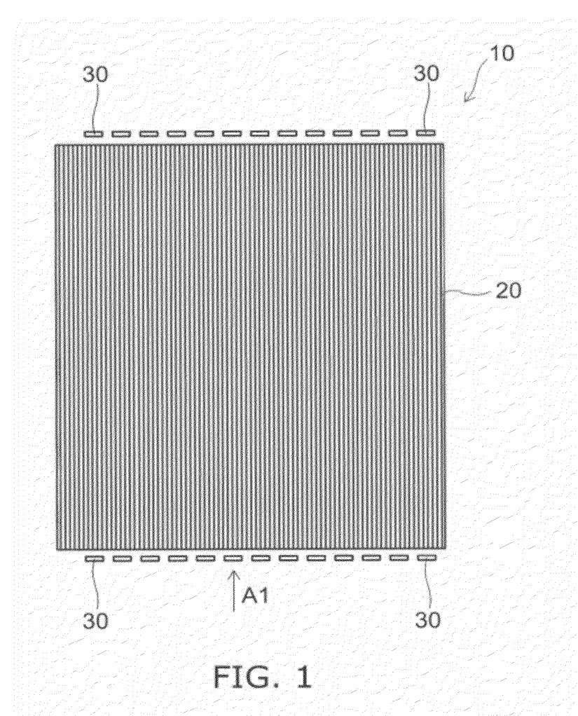

FIG. 1 is a schematic plan view showing an illumination device according to an embodiment of the invention.

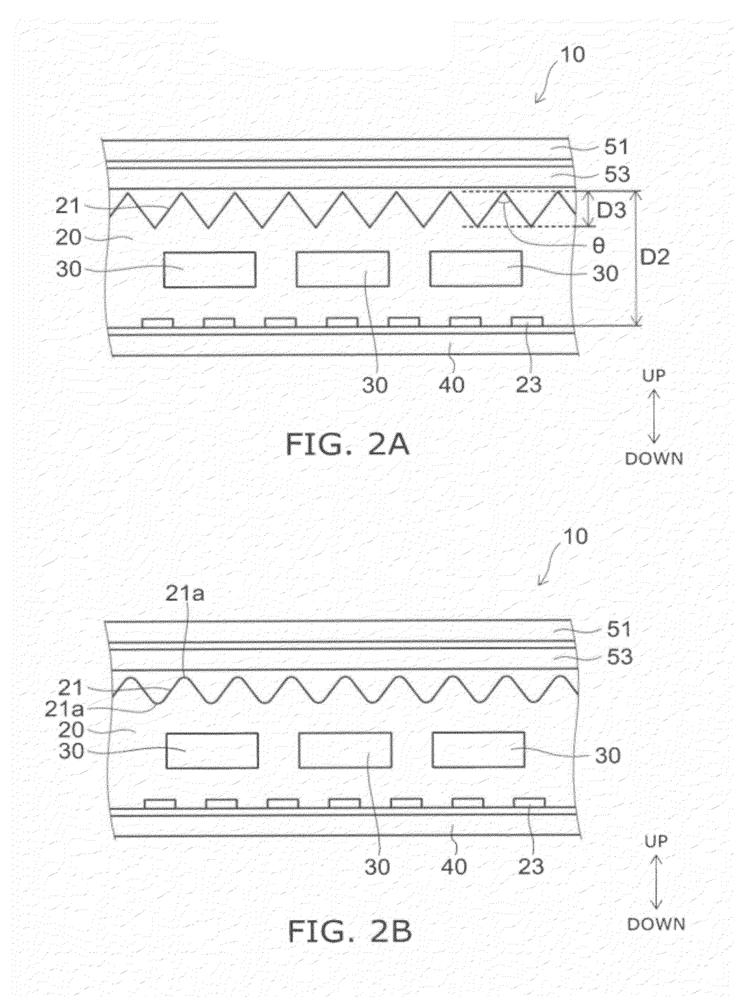

FIGS. 2A and 2B are enlarged schematic views of the illumination device according to this embodiment as viewed from the direction of arrow A1 shown in FIG. 1.

Here, FIG. 2A illustrates the case where the light guide plate includes wedge-shaped grooves. FIG. 2B illustrates the case where the light guide plate includes wave-shaped grooves.

The illumination device (backlight device) 10 according to this embodiment includes a light guide plate 20 in which a plurality of grooves 21 extending in the vertical direction (first direction) in FIG. 1 are formed at the light emitting surface (upper surface in FIGS. 2A and 2B), a plurality of light sources 30 disposed at the edge portion of the light guide plate 20, a reflecting plate 40 disposed on the opposite side of the light guide plate 20 from the light emitting surface, and a prism sheet 51 and a diffusion sheet 53 disposed on the light emitting surface side of the light guide plate 20. The reflecting plate 40 causes the light emitted downward in the light guide plate 20 to be reflected upward. The prism sheet 51 and the diffusion sheet 53 cause the luminance distribution of the light emitted from the light guide plate 20 to increase in the direction generally perpendicular to the surface of the light guide plate 20.

As shown in FIG. 1, the light sources 30 are disposed at the edge portion of the light guide plate 20, the edge portion being perpendicular to the first direction. In the illumination device 10 shown in FIGS. 1, 2A, and 2B, the light source 30 is shown as including a single light emitting element. However, the light source 30 may include a plurality of light emitting elements. The light emitting element is e.g. an LED (light emitting diode).

As shown in FIG. 2A, the light guide plate 20 includes grooves 21 shaped like wedges as viewed from the lateral side (from the direction of arrow A1 shown in FIG. 1). In this embodiment, the shape of the groove 21 as viewed from the direction of arrow A1 is not limited to the wedge shape shown in FIG. 2A, but may be a wave shape shown in FIG. 2B. The wave-shaped groove 21 shown in FIG. 2B includes not an angle portion but a curved portion 21a at the top and bottom. On the surface of the light guide plate 20 opposite from the light emitting surface, a light extraction pattern 23 for diffusing light is formed. The light extraction pattern 23 is e.g. a white ink dot pattern applied at prescribed spacings, or a prism pattern formed at prescribed spacings.

The light emitted from the light source 30 travels into the light guide plate 20 from its end surface. The light is totally reflected at the surface forming the grooves 21, the lower surface, and the side surface of the light guide plate 20. The light is then propagated in the light guide plate 20 in the direction away from the light source 30. In this propagation process, the light is scattered by the light extraction pattern 23. Alternatively, the light emitted downward without being scattered by the light extraction pattern 23 is reflected upward by the reflecting plate 40. Then, the light having deviated from the total reflection condition is emitted outward from the surface including the grooves 21 (light emitting surface). Here, by increasing the formation density of the light extraction pattern 23 at positions more downstream in the light traveling direction (closer to the center of the light guide plate 20), the light can be emitted more uniformly from the light guide plate 20. Thus, the light can be emitted in a planar configuration from the light guide plate 20.

As described above, the light guide plate 20 of this embodiment includes grooves 21 formed at the light emitting surface. Thus, the straightness of light traveling into the light guide plate 20 from its end surface can be improved. Here, the straightness of light is described in more detail with reference to the drawings.

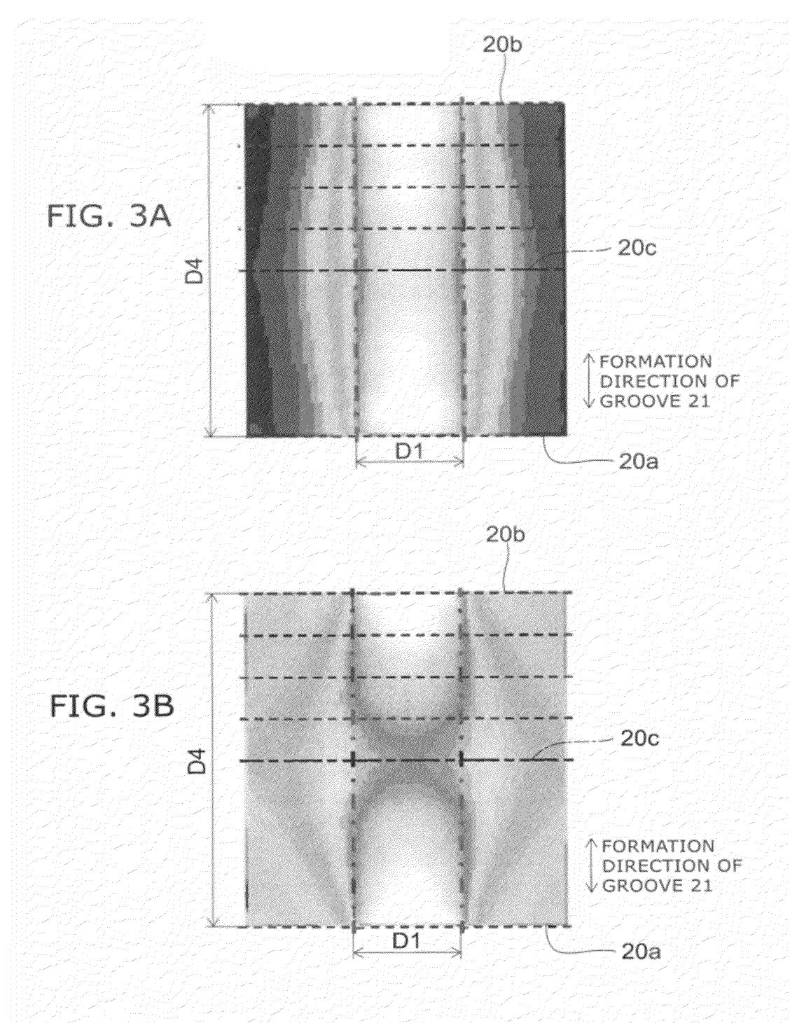

FIGS. 3A and 3B are schematic views illustrating the simulation results for the luminance distribution of the illumination device.

Here, FIG. 3A is a schematic view illustrating the simulation result for the case of using a light guide plate with grooves at the light emitting surface. FIG. 3B is a schematic view illustrating the simulation result for the case of using a light guide plate with no grooves.

First, the condition of this simulation is described.

The light sources 30 are disposed at the edge portion (upper edge portion and lower edge portion in FIGS. 3A and 3B) of the light guide plate 20, the edge portion being perpendicular to the first direction. Thus, the light emitted from the light sources 30 travels into the light guide plate 20 from its end surface 20a, 20b. The width of the light source 30 being lit is the light source lighting width D1 shown in FIGS. 3A and 3B. In this embodiment, the light source lighting width corresponds to the source-to-source distance. That is, in this description, the “source-to-source distance” refers to the minimum distance from the light source center of interest to the adjacent light source center. In other words, the “light source” refers to a collection of light emitting elements being simultaneously lit. The “source-to-source distance” refers to the minimum distance from the center of the collection (light source) to the center of the adjacent collection (light source).

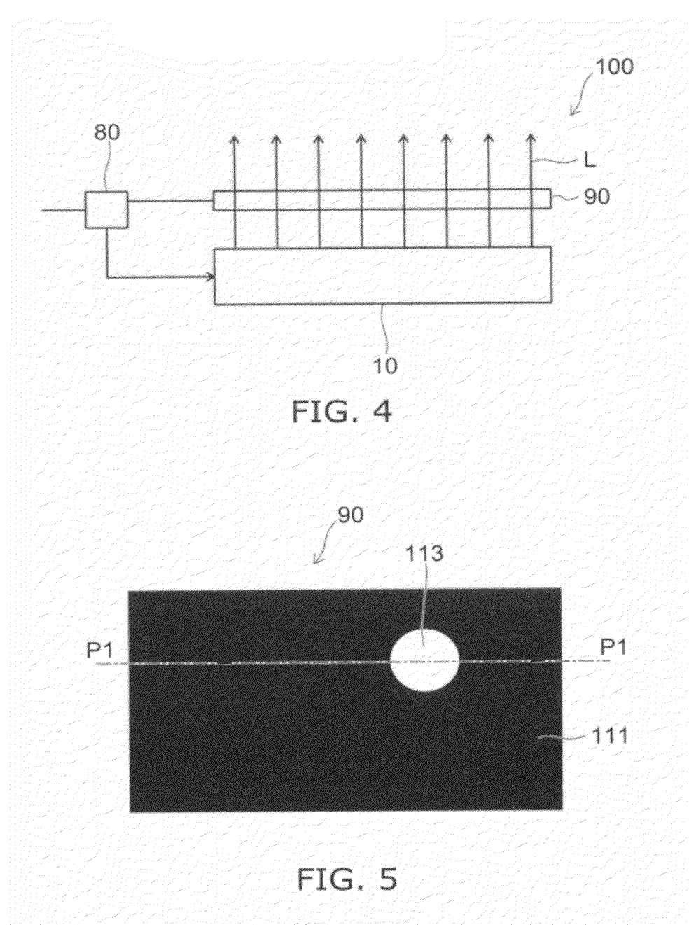

The thickness D2 (see FIG. 2A) of the light guide plate 20 is approximately 4 mm (millimeters). The depth D3 (see FIG. 2A) of the groove 21 is approximately 100 μm (microns). The vertex angle θ (see FIG. 2A) of the groove 21 is approximately 90° (degrees). The length D4 of the light guide plate 20 in the formation direction of the groove 21 (first direction) is approximately 480 mm. That is, the model of the light guide plate 20 used in this simulation is a light guide plate 20 used for a 37-inch size liquid crystal panel 90 (see FIG. 4). In this model of the light guide plate 20, the length of the long side is half the size.

Based on the above condition, the luminance distribution of the illumination device 10 is simulated. The results are as shown in FIGS. 3A and 3B.

According to the simulation results, the light traveling into the light guide plate 20 from the end surfaces 20a, 20b is propagated closer to the center portion of the light guide plate 20 in the case where the light guide plate 20 includes grooves 21 at the light emitting surface. That is, by forming grooves 21 at the light emitting surface of the light guide plate 20, the straightness of light traveling into the light guide plate 20 from the end surfaces 20a, 20b can be improved. Furthermore, as shown in FIG. 3A, in the case where the light guide plate 20 includes grooves 21 at the light emitting surface, the luminance distribution varies more gradually from the source-to-source distance D1 toward the left and right sides.

This can improve the effect of local dimming for partially controlling the luminance of the illumination device based on the brightness of the display image. Thus, the contrast can be enhanced. Here, local dimming is described with reference to the drawings.

FIG. 4 is a block diagram showing the main configuration of a liquid crystal display device according to this embodiment.

FIG. 5 is a schematic plan view illustrating an image displayed on the liquid crystal panel.

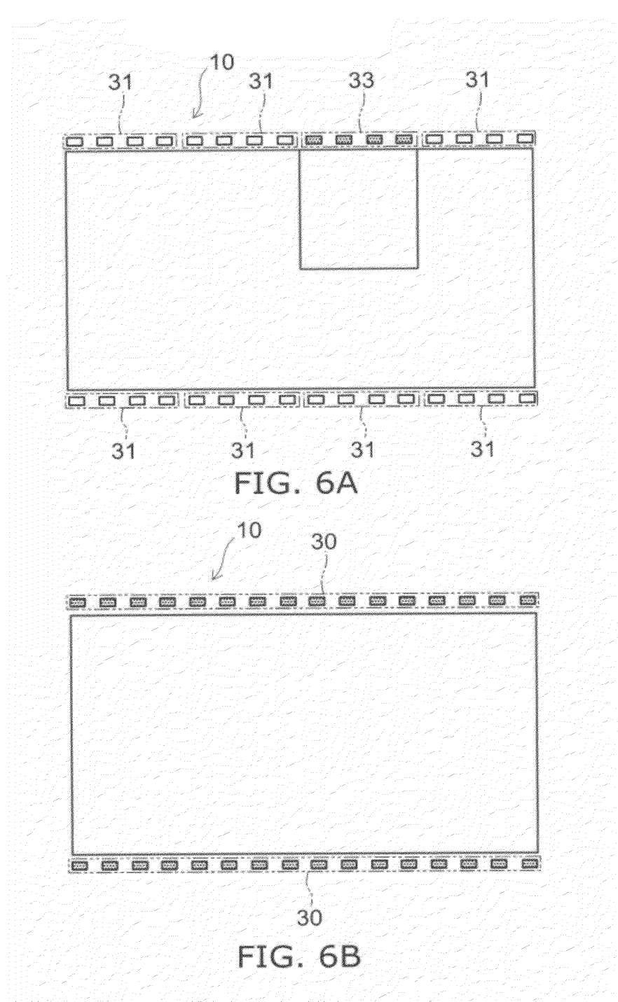

FIGS. 6A and 6B are schematic plan views showing the lighting state of the light sources.

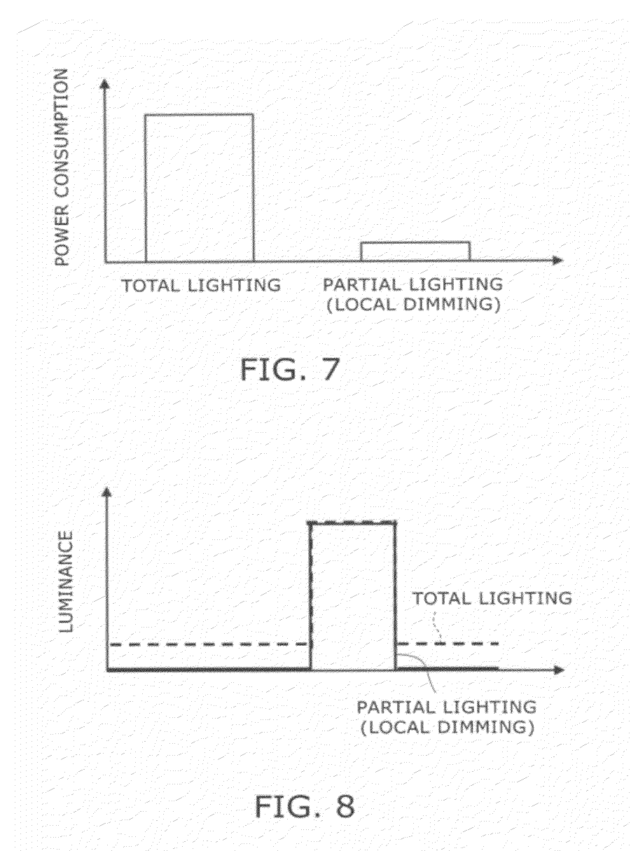

FIG. 7 is a graph comparing the power consumption.

FIG. 8 is a graph comparing the luminance at positions P1-P1 shown in FIG. 5.

Here, FIG. 6A is a schematic plan view showing the state of local dimming. FIG. 6B is a schematic plan view showing the state of lighting all the light sources 30.

As shown in FIG. 4, the liquid crystal display device 100 according to this embodiment includes an illumination device 10, a controller 80, and a liquid crystal panel 90. To the controller 80, an image signal is inputted from outside. The controller 80 determines the luminance of the illumination device 10 based on the inputted image signal and corrects the image signal. To the illumination device 10, an illumination control signal is inputted from the controller 80. To the liquid crystal panel 90, the corrected image signal is inputted from the controller 80. The illumination device 10 emits light in response to the illumination control signal from the controller 80, and irradiates the liquid crystal panel 90 with light L from the back side of the display surface of the liquid crystal display device 100. The liquid crystal panel 90 varies the optical transmittance of each pixel on the liquid crystal panel 90 in response to the image signal from the controller 80, thereby varying the amount of light transmitted through each pixel.

In this description, the intensity of light leaking out of the front surface of the liquid crystal panel 90 when the optical transmittance of the liquid crystal panel 90 is maximized, i.e., the luminance observed on the front surface side of the liquid crystal panel 90 when the optical transmittance of the liquid crystal panel 90 is maximized, is regarded as the light emission luminance of the light source 30 for convenience. It can be safely said that this light emission luminance of the light source 30 is nearly proportional to the intensity of light incident on the liquid crystal panel 90.

In the case where the optical transmittance of the pixels on the liquid crystal panel 90 is made uniform, the distribution of light emission luminance of the light sources 30 observed on the front surface side of the liquid crystal panel 90 is referred to as the light emission luminance distribution of the light sources 30. This distribution (geometry) of light emission luminance of the light sources 30 can be regarded as being nearly equivalent to the distribution (geometry) of the intensity of light incident on the liquid crystal panel 90. This is because it can be safely said that the light emission luminance of the light source 30 is nearly proportional to the intensity of light incident on the liquid crystal panel 90.

For instance, FIG. 5 shows an example in which the image of a bright object 113 against a dark background 111 is displayed on the liquid crystal panel 90. In performing local dimming, as shown in FIG. 6A, the controller 80 calculates the setting value of the luminance of each light source 30 so that the light source 31 near the dark background 111 is lit dark and the light source 33 near the bright object 113 is lit bright. For instance, from the inputted image signal, the average luminance of the pixels located near and around each light source 30 is calculated. Based on the calculated average luminance, the luminance setting value of each light source 30 is calculated. Alternatively, from the inputted image signal, the maximum luminance of the pixels located near and around each light source 30 is calculated. Based on the calculated maximum luminance, the luminance setting value of each light source 30 is calculated. Other known techniques can also be used to calculate the luminance setting value of each light source 30.

In view of the characteristics of the liquid crystal panel 90, in general, it is very difficult to set the optical transmittance of the liquid crystal panel 90 to zero. In the case as shown in FIG. 6B, the luminance control cannot be performed for each light source 30, but all the light sources 30 can only be lit with the same luminance. In this case, in displaying a completely dark portion, the luminance of that portion cannot be sufficiently darkened. This is because the optical transmittance of the liquid crystal panel 90 cannot be set to zero, and the light of the light source 30 considerably leaks out of the front surface of the liquid crystal panel 90.

In contrast, local dimming by the controller 80 can avoid unnecessary lighting of the light source 30, such as brightly lighting the light source 30 despite displaying a dark portion. This enables image display with low power consumption as shown in FIG. 7. Furthermore, local dimming by the controller 80 can display the dark portion more darkly while maintaining the brightness of the bright portion. This enables image display with high contrast and sharpness as shown in FIG. 8.

However, as shown in FIG. 8, the light emission luminance distribution of the light sources 30 may steeply vary at the boundary between the light sources. In this case, a steep luminance variation not existing in the input image signal occurs at the boundary between the light sources in the luminance distribution of the image displayed on the liquid crystal display device 100. This phenomenon is caused by the variation in the luminance distribution of the illumination device 10 reflected on the display image because the correction of the image signal fails to sufficiently compensate for the variation in the luminance distribution of the illumination device 10. If such a phenomenon occurs, the dark portion around the bright portion is made unnaturally bright, which is perceived as luminance unevenness. In the case where the light emission luminance distribution of the light sources 30 includes a steeply varying site, this luminance unevenness is perceived conspicuously.

In contrast, there exists an ideal luminance distribution capable of suppressing luminance unevenness and suppressing the weakening of the contrast enhancement effect as much as possible. Next, the ideal luminance distribution is described with reference to the drawings.

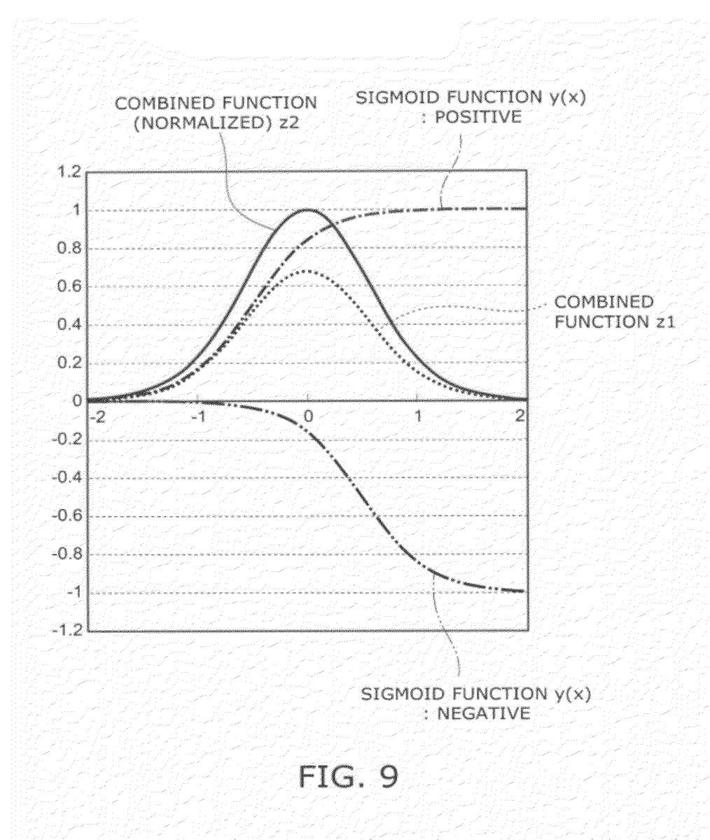

FIG. 9 is a graph for describing the ideal luminance distribution.

The ideal luminance distribution is determined by first determining the combined function z1 of the positive sigmoid function and the negative sigmoid function shown in FIG. 9. The sigmoid function is given by equation (1), with the gain denoted by “a”.

y(x)=1/(1+exp(−ax)) (1)

Next, the combined function z1 is normalized by its maximum to determine a combined function z2. This normalized combined function z2 represents the ideal luminance distribution. The ideal luminance distribution is described in more detail with reference to the drawings.

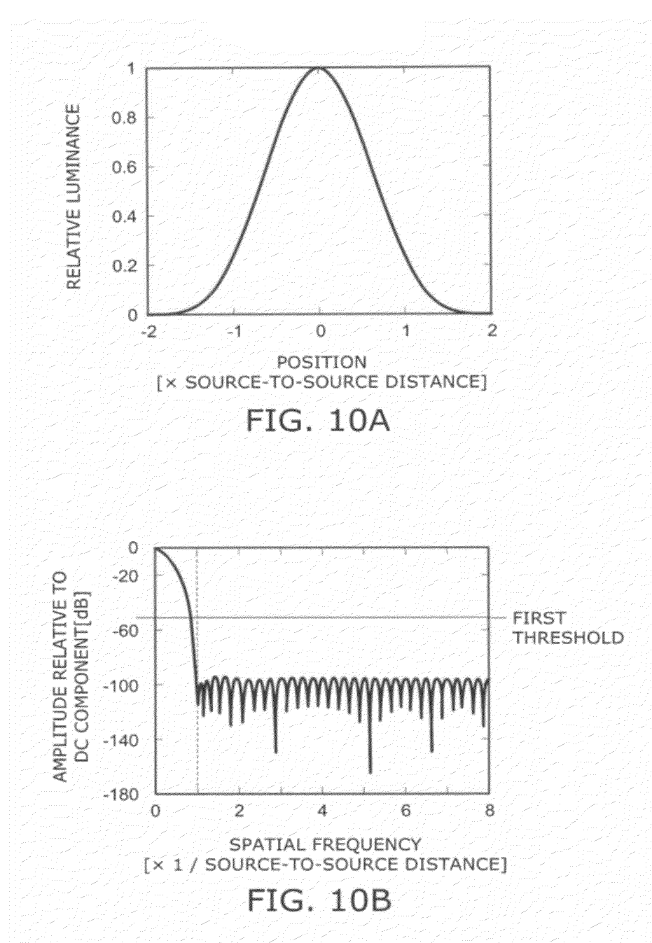

FIGS. 10A and 10B are graphs illustrating a light emission luminance distribution of the light sources of this embodiment.

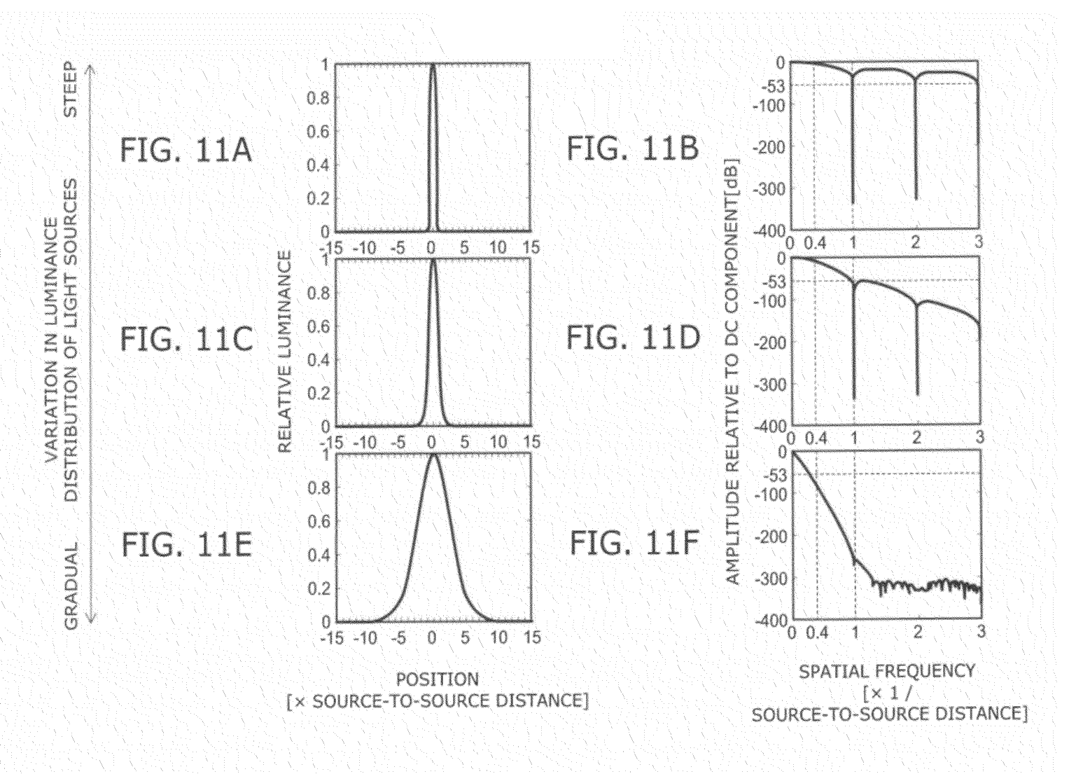

FIGS. 11A to 11F are graphs for describing the relationship between the shape of the luminance distribution of the light sources of this embodiment and the spatial frequency component thereof.

Here, FIG. 10A is a graph illustrating the light emission luminance distribution of the light sources 30. FIG. 10B is a graph illustrating the amplitude of each spatial frequency component of the light emission luminance distribution of the light sources 30. In FIG. 10A, the magnitude of light emission luminance of the light source 30 is represented by the relative luminance normalized by the maximum light emission luminance of the light source 30. This also applies to the magnitude of light emission luminance of the light source 30 described below with reference to FIGS. 11A, 11C, 11E, 12A, and 13A. In FIG. 10B, the amplitude of the spatial frequency component of the light emission luminance distribution of the light sources 30 is represented by the amplitude relative to the DC component. FIGS. 11A, 11C, and 11E are graphs illustrating the light emission luminance distribution of the light sources 30. FIGS. 11B, 11D, and 11F are graphs illustrating the amplitude of each spatial frequency component of the light emission luminance distribution of the light sources 30.

In general, an arbitrary function g(x) representing the distribution of given values on the real space can be expressed as the sum of a plurality of sinusoidal waves with different spatial frequencies. Here, x denotes the position or coordinate on the real space. The sinusoidal wave constituting the function g(x) is called the component of g(x). The amplitude (intensity) of the component of g(x) at an arbitrary spatial frequency fx can be determined by Fourier transformation of g(x). The function g(x) and the function G(fx) obtained by Fourier transformation of the function g(x) are in one-to-one correspondence, and represent a single identical distribution. For a certain distribution, g(x) is called the function (distribution) in the spatial region, whereas G(fx) is called the function (distribution) in the spatial frequency region. For instance, the amplitude of each spatial frequency component included in the light emission luminance distribution of the light sources 30 as shown in FIG. 10A is as shown in FIG. 10B. Conversely, the light emission luminance distribution of the light sources 30 shown in FIG. 10A is constituted by sinusoidal waves with spatial frequencies and amplitudes as shown in FIG. 10B. The component with a spatial frequency of 0 Hz (hertz) shown in FIG. 10A is the constant component with no spatial variation in luminance, and called the DC component.

As shown in FIG. 10B, the amplitude of the spatial frequency component of the light emission luminance distribution of the light sources 30 is assumed to be less than or equal to a first threshold for the spatial frequency greater than or equal to 1/(source-to-source distance). This first threshold can be set to the minimum contrast perceptible to a human. The minimum contrast perceptible to a human is called the contrast threshold, for instance. The minimum contrast threshold commonly known is approximately −53 dB (decibels). Thus, the first threshold may be set to −53 dB.

Then, as seen from FIGS. 11A to 11F, in a light emission luminance distribution having a steeper variation, the intensity (amplitude) of the component with high spatial frequency is larger. On the other hand, in a light emission luminance distribution having a more gradual variation, the intensity (amplitude) of the component with high spatial frequency is smaller. This is because the light emission luminance distribution having a steep variation requires the component with high spatial frequency for the steeply varying portion. Conversely, the luminance distribution which does not substantially include the component with high spatial frequency is free from the steeply varying portion. That is, in the amplitude of the spatial frequency component of the light emission luminance distribution of the light sources 30 shown in FIG. 10B, the variation of the light emission luminance distribution is more gradual throughout the light emission luminance distribution as compared with the light sources 30 whose light emission luminance distribution includes the component with high spatial frequency greater than or equal to the first threshold.

Accordingly, in contrast to the case where the light emission luminance distribution of the light sources 30 includes a steeply varying site, a steep luminance variation not existing in the input image signal does not occur in the display image. Here, as in the case where the light emission luminance distribution of the light sources 30 includes a steeply varying site, there may occur a phenomenon in which the correction of the image signal fails to sufficiently compensate for the variation in the luminance distribution of the illumination device 10. In this phenomenon, the variation in the luminance distribution of the illumination device 10 is reflected on the display image. However, the light emission luminance distribution of the light sources 30 does not include a steeply varying site. Hence, even if a luminance variation not existing in the input image signal occurs on the display image, the luminance variation is not a steep variation. In general, the human perception is less sensitive to a gradual luminance variation with low spatial frequency. Hence, even if luminance unevenness is caused by the principle described above, it is less perceptible to the observer. Accordingly, the effect is that luminance unevenness is less perceptible because the high frequency component in the light emission luminance distribution of the light sources 30 is weak.

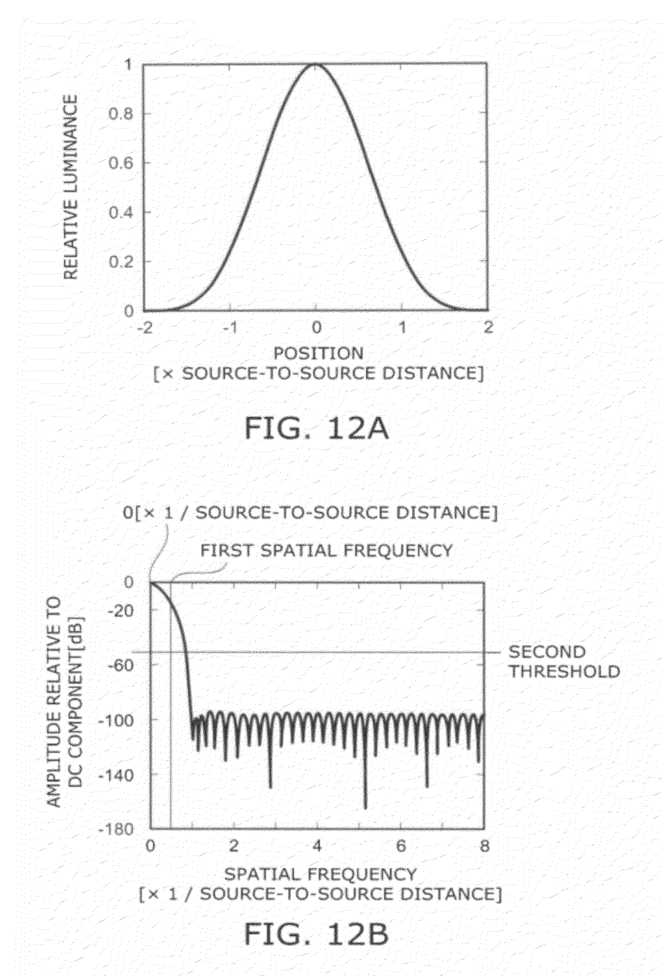

FIGS. 12A and 12B are graphs illustrating another light emission luminance distribution of the light sources of this embodiment.

Here, FIG. 12A is a graph illustrating the light emission luminance distribution of the light sources 30. FIG. 12B is a graph illustrating the amplitude of each spatial frequency component of the light emission luminance distribution of the light sources 30. In FIG. 12B, the amplitude of the spatial frequency component of the light emission luminance distribution of the light sources 30 is represented by the amplitude relative to the DC component. Furthermore, the spatial frequency of the DC component (0 [×1/source-to-source distance]) is referred to herein as spatial frequency 0.

As shown in FIG. 12B, the amplitude of the spatial frequency component of the light emission luminance distribution of the light sources 30 is assumed to be greater than or equal to a second threshold in the range from the spatial frequency of the DC component (0 [×1/source-to-source distance]) to a first spatial frequency. The first spatial frequency [×1/source-to-source distance] has a value greater than 0 and less than 1, such as 0.4/(source-to-source distance). The second threshold is the minimum contrast perceptible to a human. Like the first threshold described above with reference to FIGS. 10A, 10B, and 11A to 11F, the second threshold may be set to −53 dB.

Then, as seen from FIGS. 11A to 11F, in a light emission luminance distribution having a more gradual variation, the intensity (amplitude) is smaller down to the component with lower spatial frequency. On the other hand, in a light emission luminance distribution having a steeper variation, the intensity (amplitude) is large up to the component with higher spatial frequency. This is because the light emission luminance distribution having a steeper variation requires up to the component with higher spatial frequency. Conversely, a light emission luminance distribution including the component with large intensity (amplitude) up to higher spatial frequency can vary more steeply. That is, the amplitude of the spatial frequency component of the light emission luminance distribution of the light sources 30 shown in FIG. 12B allows a steeper variation as compared with the light sources in which the intensity (amplitude) of the light emission luminance distribution is less than the second threshold in the range from the spatial frequency of the DC component (0 [×1/source-to-source distance]) to the first spatial frequency.

Accordingly, in contrast to the case where the light emission luminance distribution of the light sources 30 varies gradually, the variation width of the light emission luminance of the illumination device 10 is large. Large variation width of the light emission luminance of the illumination device 10 means that the effect due to controlling the light emission luminance for each light source 30 is significant. That is, image display with high contrast and sharpness is fully feasible. Accordingly, the effect is that image display with high contrast and sharpness can be achieved because the low frequency component in the light emission luminance distribution of the light sources 30 is sufficiently intense.

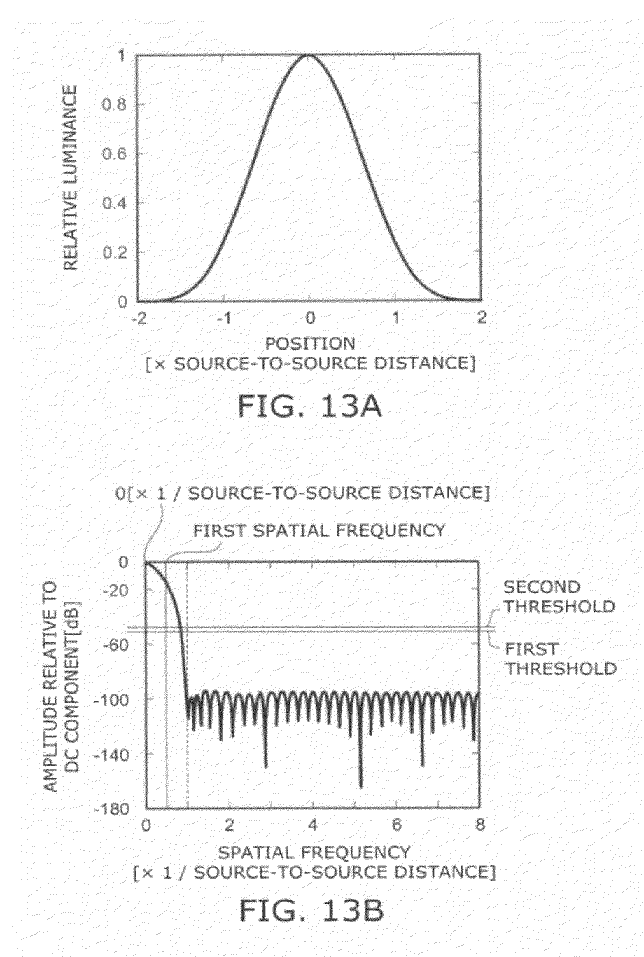

FIGS. 13A and 13B are graphs illustrating still another light emission luminance distribution of the light sources of this embodiment.

Here, FIG. 13A is a graph illustrating the light emission luminance distribution of the light sources 30. FIG. 13B is a graph illustrating the amplitude of each spatial frequency component of the light emission luminance distribution of the light sources 30. In FIG. 13B, the amplitude of the spatial frequency component of the light emission luminance distribution of the light sources 30 is represented by the amplitude relative to the DC component. Furthermore, the spatial frequency of the DC component (0 [×1/source-to-source distance]) is referred to herein as spatial frequency 0.

As shown in FIG. 13B, the amplitude of the spatial frequency component of the light emission luminance distribution of the light sources 30 is assumed to be less than or equal to the first threshold for the spatial frequency greater than or equal to 1/(source-to-source distance), and to be greater than or equal to the second threshold in the range from the spatial frequency of the DC component to the first spatial frequency. That is, the amplitude of the spatial frequency component shown in FIG. 13B satisfies the combination of the condition described above with reference to FIGS. 10A and 10B and the condition described above with reference to FIGS. 12A and 12B.

Thus, like the effect described above with reference to FIGS. 10A and 10B, one effect is that luminance unevenness is less perceptible because the high frequency component in the light emission luminance distribution of the light sources 30 is weak. Furthermore, like the effect described above with reference to FIGS. 12A and 12B, another effect is that image display with high contrast and sharpness can be achieved because the low frequency component in the light emission luminance distribution of the light sources 30 is sufficiently intense. Accordingly, the effect is that luminance unevenness is less perceptible because the high frequency component in the light emission luminance distribution of the light sources 30 is weak, and that image display with high contrast and sharpness can be achieved because the low frequency component in the light emission luminance distribution of the light sources 30 is sufficiently intense.

As described above with reference to FIGS. 9 to 13B, the amplitude of the spatial frequency component of the light emission luminance distribution of the light sources 30 is limited to a prescribed condition to obtain an ideal luminance distribution. This can suppress luminance unevenness and suppress the weakening of the contrast enhancement effect as much as possible. Alternatively, this enables image display with less perceptible luminance unevenness and high contrast and sharpness. Alternatively, this can suppress luminance unevenness and suppress the weakening of the contrast enhancement effect as much as possible, and enables image display with less perceptible luminance unevenness and high contrast and sharpness. Thus, by making the luminance distribution of the illumination device 10 close to the ideal luminance distribution, the effect of local dimming can be improved.

Next, the source-to-source distance D1 (see FIGS. 3A and 3B) for making the luminance distribution of the illumination device 10 close to the ideal luminance distribution is described with reference to the drawings.

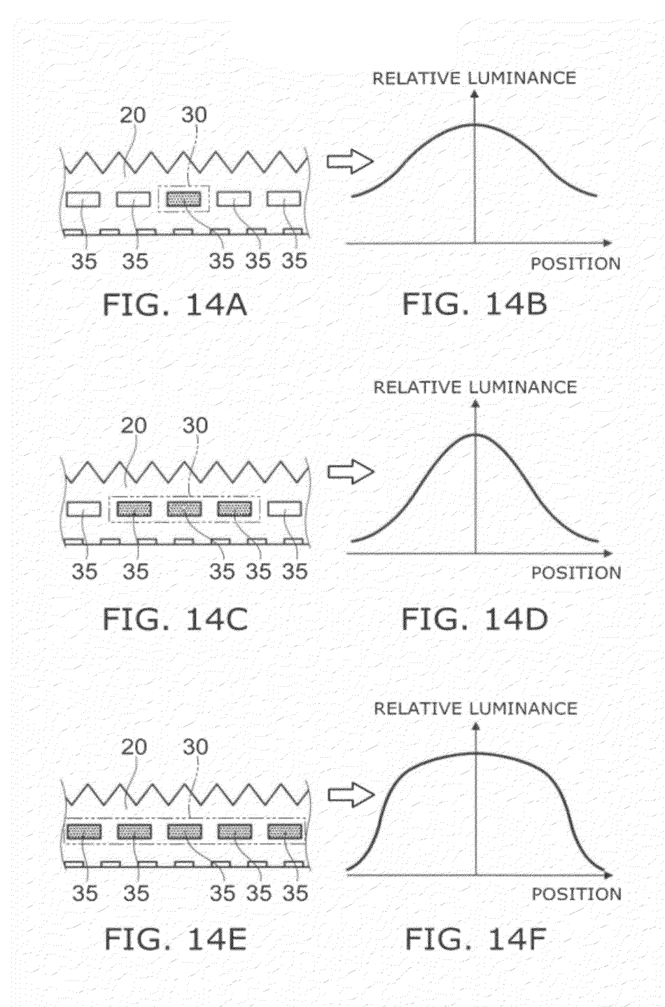

FIGS. 14A to 14F are graphs illustrating the relationship between the light sources and the luminance distribution.

Here, FIGS. 14A, 14C, and 14E are schematic plan views for different numbers of light emitting elements 35 being lit. FIGS. 14B, 14D, and 14F are graphs showing the luminance distribution of the illumination device 10 in which the number of light emitting elements 35 being lit corresponds to FIGS. 14A, 14C, and 14E, respectively.

Varying the source-to-source distance D1 results in varying the luminance distribution of the illumination device 10. In FIGS. 14A and 14B, for instance, one light emitting element 35 is lit. Then, the variation width of the light emission luminance of the illumination device 10 is smaller. This means that the effect of local dimming is weak. That is, image display with high contrast and sharpness cannot be achieved. In this case, lighting any light source 30 only results in uniformly varying the luminance of the entire surface of the illumination device 10. Thus, local dimming fails to provide spatial change in the luminance distribution of the illumination device 10. That is, local dimming does not make sense.

On the other hand, in FIGS. 14E and 14F, for instance, five light emitting elements 35 are lit. Then, the variation width of the light emission luminance of the illumination device is larger. However, the luminance distribution of the illumination device 10 varies more steeply at the boundary between the light sources. Thus, the luminance unevenness is perceptible.

In contrast, in FIGS. 14C and 14D, for instance, three light emitting elements 35 are lit. Then, the luminance distribution of the illumination device 10 varies gradually throughout the luminance distribution. This enables image display with less perceptible luminance unevenness and high contrast and sharpness. That is, the effect of local dimming can be improved. Thus, there exists a source-to-source distance D1 for making the luminance distribution of the illumination device 10 close to the ideal luminance distribution.

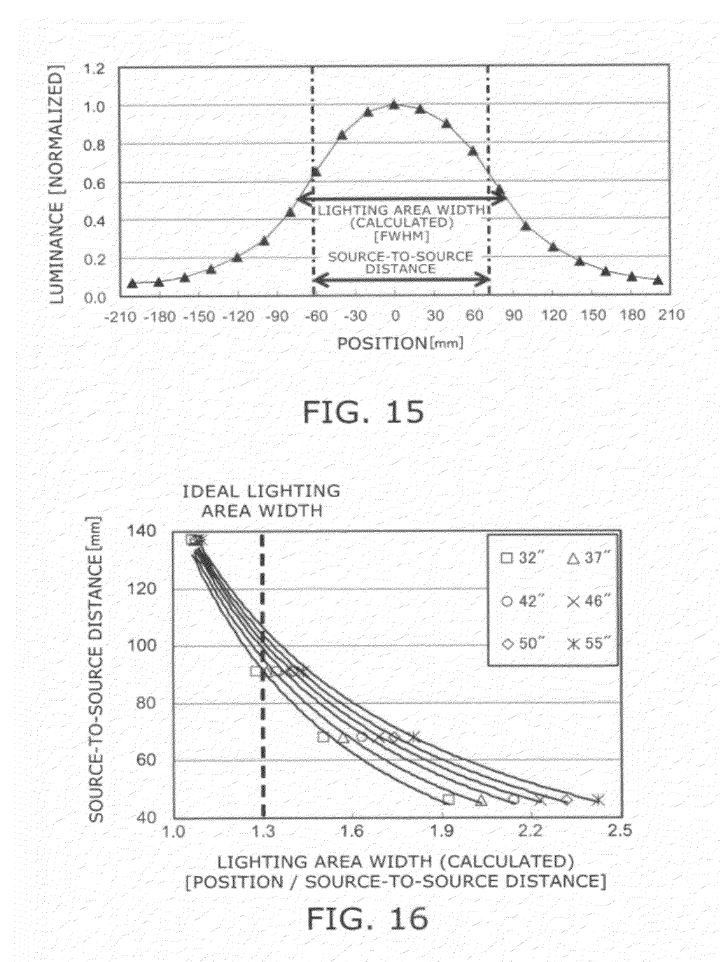

FIG. 15 is a graph illustrating the relationship between the ideal luminance distribution and the source-to-source distance.

FIG. 16 is a graph for describing the optimization of the source-to-source distance.

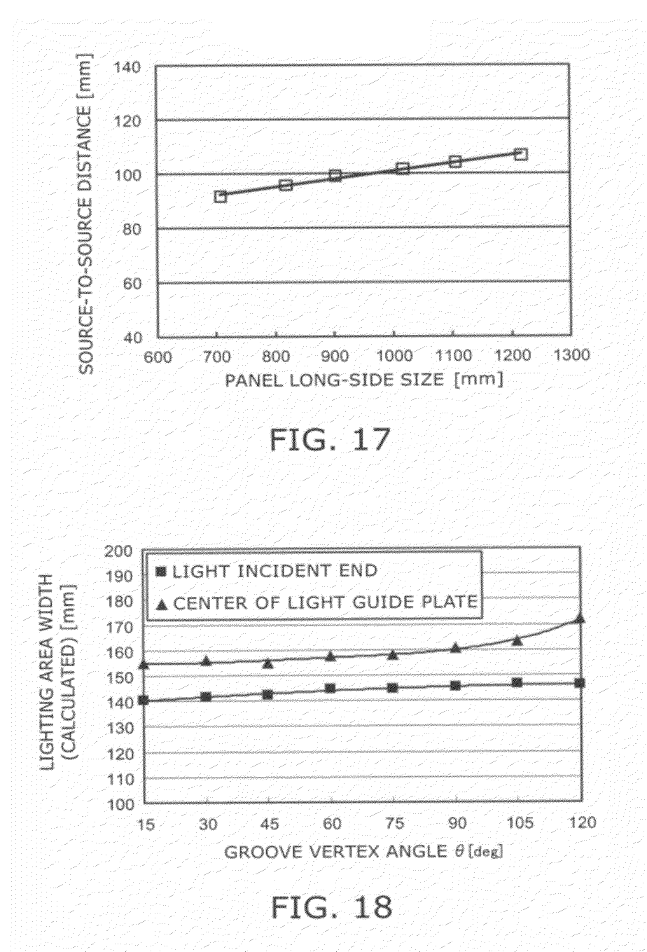

FIG. 17 is a graph illustrating the optimized source-to-source distance.

The relationship between the ideal luminance distribution and the source-to-source distance D1 is as shown in FIG. 15. The luminance distribution shown in FIG. 15 represents the luminance distribution at the center portion 20c of the light guide plate 20 shown in FIG. 3A. That is, FIG. 15 shows the luminance distribution at the center portion 20c of the light guide plate 20 used for a 37-inch size liquid crystal panel 90. The thickness D2 of the light guide plate 20, the depth D3 of the groove, and the vertex angle θ of the groove are as described above with reference to FIGS. 3A and 3B. In FIG. 15, the magnitude of light emission luminance of the illumination device 10 is represented by the relative luminance normalized by the maximum light emission luminance of the illumination device 10. In this description, the full width at half maximum of the relative luminance normalized by the maximum light emission luminance of the illumination device 10 is referred to as “lighting area width”.

The relationship between the lighting area width and the source-to-source distance D1 is as shown in FIG. 16. The curves represent the relationship for different sizes of the liquid crystal panel 90 of the liquid crystal display device 100. Here, variation in the source-to-source distance results in varying the lighting area width. Hence, the horizontal axis of the graph shown in FIG. 16 represents the lighting area width normalized by the source-to-source distance D1. Here, as seen in the graph shown in FIG. 15, in the ideal luminance distribution, the lighting area width is 1.3. That is, an ideal lighting area width is 1.3. Thus, based on the graph shown in FIG. 16, in the case of using a liquid crystal panel 90 of the 32-inch, 37-inch, 42-inch, 46-inch, 50-inch, and 55-inch size, the ideal lighting area width can be obtained by setting the source-to-source distance D1 to e.g. approximately 90-110 mm. That is, in the case of using a liquid crystal panel 90 of the 32-inch, 37-inch, 42-inch, 46-inch, 50-inch, and 55-inch size, the luminance distribution of the illumination device 10 can be made close to the ideal luminance distribution by setting the source-to-source distance D1 to e.g. approximately 90-110 mm.

The relationship between the size of the long side of the liquid crystal panel 90 and the source-to-source distance D1 is as shown in FIG. 17. FIG. 17 is a graph showing the relationship between the optimized source-to-source distance D1 shown in FIG. 16 (the source-to-source distance satisfying the ideal lighting area width, 1.3) and the size of the long side of the liquid crystal panel 90. Based thereon, in the case where the thickness D2 of the light guide plate 20 is 4 mm, the luminance distribution of the illumination device 10 can be made close to the ideal luminance distribution by setting the source-to-source distance D1 so as to satisfy equation (2). Thus, the effect of local dimming can be improved.

Optimized source-to-source distance [mm]=0.029×liquid crystal panel long-side size [mm]+71.886 (2)

Next, the variation of the lighting area width in response to the variation of the shape of the groove 21 is described with reference to the drawings.

FIG. 18 is a graph showing the relationship between the vertex angle of the groove of the light guide plate of this embodiment and the lighting area width.

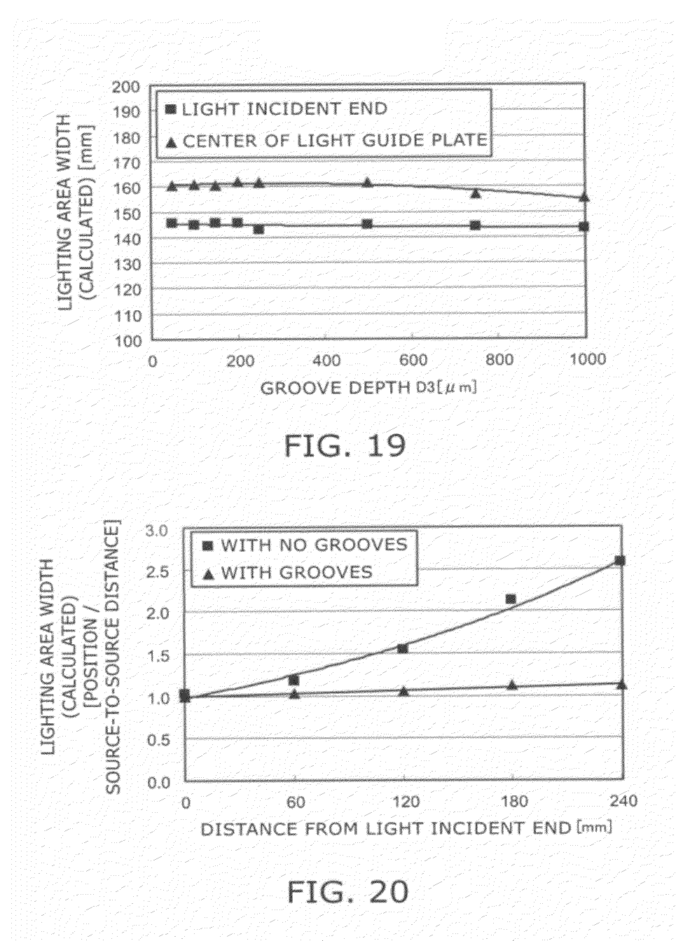

FIG. 19 is a graph showing the relationship between the depth of the groove of the light guide plate of this embodiment and the lighting area width.

FIG. 20 is a graph showing the relationship between the distance from the light incident end of the light guide plate of this embodiment and the lighting area width.

The inventors simulated the variation of the lighting area width with the vertex angle θ of the groove 21 of the light guide plate 20 varied between 15° and 120°. The result is as shown in FIG. 18. Here, the thickness D2 of the light guide plate 20 and the depth D3 of the groove 21 are similar to the simulation condition described above with reference to FIGS. 3A and 3B. As seen in the graph shown in FIG. 18, the variation of the lighting area width at the end surfaces 20a, 20b (see FIGS. 3A and 3B) of the light guide plate 20 on which the light emitted from the light source 30 is incident is relatively small even if the vertex angle θ of the groove 21 of the light guide plate 20 is varied between 15° and 120°. Furthermore, the variation of the lighting area width at the center portion 20c of the light guide plate 20 is relatively small like the variation of the lighting area width at the end surfaces 20a, 20b of the light guide plate 20.

Furthermore, the inventors simulated the variation of the lighting area width with the depth D3 of the groove 21 of the light guide plate 20 varied between 50 μm and 1 mm. The result is as shown in FIG. 19. Here, the thickness D2 of the light guide plate 20 and the vertex angle θ of the groove 21 are similar to the simulation condition described above with reference to FIGS. 3A and 3B. As seen in the graph shown in FIG. 19, the variation of the lighting area width at the end surfaces 20a, 20b and the center portion 20c of the light guide plate 20 is relatively small even if the depth D3 of the groove 21 of the light guide plate 20 is varied between 50 μm and 1 mm.

Furthermore, the inventors simulated the variation of the lighting area width depending on the presence and absence of the groove 21 of the light guide plate 20. The result is as shown in FIG. 20. Here, the thickness D2 of the light guide plate 20, the depth D3 of the groove 21, and the vertex angle θ of the groove 21 are similar to the simulation condition described above with reference to FIGS. 3A and 3B. The vertical axis of the graph shown in FIG. 20 represents the lighting area width normalized by the source-to-source distance D1. As seen in the graph shown in FIG. 20, in the case where no grooves 21 are formed at the light emitting surface of the light guide plate 20, the lighting area width increases with the distance away from the end surface 20a, 20b toward the center portion 20c of the light guide plate 20. That is, the straightness of light traveling into the light guide plate 20 from its end surface 20a, 20b is not improved.

In contrast, in the case where grooves 21 are formed at the light emitting surface of the light guide plate 20, the variation of the lighting area width is relatively small irrespective of the distance away from the end surface 20a, 20b toward the center portion 20c of the light guide plate 20. That is, by forming grooves 21 at the light emitting surface of the light guide plate 20, the straightness of light traveling into the light guide plate 20 from its end surface 20a, 20b can be improved.

As described above, according to this embodiment, by optimizing the source-to-source distance D1, an ideal lighting area width can be obtained. That is, by optimizing the source-to-source distance D1, the luminance distribution of the illumination device 10 can be made close to the ideal luminance distribution. Thus, the effect of local dimming can be improved.

This embodiment has been described primarily with reference to examples in which the illumination device 10 performs local dimming. However, this embodiment is not limited thereto. For instance, this embodiment is also applicable to scanning lighting or segment lighting in which the light sources 30 are successively lit to cause the light guide plate 20 to successively emit light. This can reduce the feeling of persistence of vision to eliminate blurring of moving images. Furthermore, the light source 30 is turned off during displaying black. Hence, the contrast of the image can be enhanced. Furthermore, the power consumption can be reduced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An illumination device comprising:
a light guide plate including a light emitting surface at which a plurality of grooves extending in a first direction are formed; and
a plurality of light sources whose light emission luminance can be controlled individually, the light sources being configured to supply light from an edge portion of the light guide plate into the light guide plate, the edge portion being perpendicular to the first direction,
a luminance distribution of light injected from the light sources into the light guide plate and emitted from the light emitting surface is obtained by a function such that relative intensity relative to a DC component in a spatial frequency region is less than or equal to a first threshold in a spatial frequency region having a value of one or more, and
source-to-source distance of the light sources is optimized by the luminance distribution of the light.

2. An illumination device comprising:
a light guide plate including a light emitting surface at which a plurality of grooves extending in a first direction are formed; and
a plurality of light sources whose light emission luminance can be controlled individually, the light sources being configured to supply light from an edge portion of the light guide plate into the light guide plate, the edge portion being perpendicular to the first direction,
a luminance distribution of light injected from the light sources into the light guide plate and emitted from the light emitting surface is obtained by a function such that relative intensity relative to a DC component in a spatial frequency region is greater than or equal to a second threshold in a spatial frequency region less than or equal to a first spatial frequency having a spatial frequency value of greater than zero and less than one, and
source-to-source distance of the light sources is optimized by the luminance distribution of the light.

3. An illumination device comprising:
a light guide plate including a light emitting surface at which a plurality of grooves extending in a first direction are formed; and
a plurality of light sources whose light emission luminance can be controlled individually, the light sources being configured to supply light from an edge portion of the light guide plate into the light guide plate, the edge portion being perpendicular to the first direction,
a luminance distribution of light injected from the light sources into the light guide plate and emitted from the light emitting surface is obtained by a function such that relative intensity relative to a DC component in a spatial frequency region is less than or equal to a first threshold in a spatial frequency region having a value of one or more, and is greater than or equal to a second threshold in a spatial frequency region less than or equal to a first spatial frequency having a spatial frequency value of greater than zero and less than one, and
source-to-source distance of the light sources is optimized by the luminance distribution of the light.

4. The device according to claim 1, wherein lighting area width is 1.3, the lighting area width being a full width at half maximum of the luminance distribution of the light normalized by the source-to-source distance.

5. The device according to claim 2, wherein lighting area width is 1.3, the lighting area width being a full width at half maximum of the luminance distribution of the light normalized by the source-to-source distance.

6. The device according to claim 3, wherein lighting area width is 1.3, the lighting area width being a full width at half maximum of the luminance distribution of the light normalized by the source-to-source distance.

7. The device according to claim 1, wherein
the device is used in conjunction with a liquid crystal panel of 32-inch to 55-inch size, and
the optimized source-to-source distance satisfies a relation
optimized source-to-source distance [mm]=0.029×liquid crystal panel long-side size [mm]+71.886
when the light guide plate has a thickness of 4 mm.

8. The device according to claim 2, wherein
the device is used in conjunction with a liquid crystal panel of 32-inch to 55-inch size, and
the optimized source-to-source distance satisfies a relation
optimized source-to-source distance [mm]=0.029×liquid crystal panel long-side size [mm]+71.886
when the light guide plate has a thickness of 4 mm.

9. The device according to claim 3, wherein
the device is used in conjunction with a liquid crystal panel of 32-inch to 55-inch size, and
the optimized source-to-source distance satisfies a relation
optimized source-to-source distance [mm]=0.029×liquid crystal panel long-side size [mm]+71.886
when the light guide plate has a thickness of 4 mm.

10. A liquid crystal display device comprising:
an illumination device including:
a light guide plate including a light emitting surface at which a plurality of grooves extending in a first direction are formed; and
a plurality of light sources whose light emission luminance can be controlled individually, the light sources being configured to supply light from an edge portion of the light guide plate into the light guide plate, the edge portion being perpendicular to the first direction,
a luminance distribution of light injected from the light sources into the light guide plate and emitted from the light emitting surface is obtained by a function such that relative intensity relative to a DC component in a spatial frequency region is less than or equal to a first threshold in a spatial frequency region having a value of one or more, and
source-to-source distance of the light sources is optimized by the luminance distribution of the light;
a liquid crystal panel irradiated with light by the illumination device; and
a controller configured to input an image signal to the liquid crystal panel and to input an illumination control signal to the illumination device, the illumination control signal being configured to individually control the light emission luminance of the a plurality of light sources based on the image signal.

11. A liquid crystal display device comprising:
an illumination device including:
a light guide plate including a light emitting surface at which a plurality of grooves extending in a first direction are formed; and
a plurality of light sources whose light emission luminance can be controlled individually, the light sources being configured to supply light from an edge portion of the light guide plate into the light guide plate, the edge portion being perpendicular to the first direction,
a luminance distribution of light injected from the light sources into the light guide plate and emitted from the light emitting surface is obtained by a function such that relative intensity relative to a DC component in a spatial frequency region is greater than or equal to a second threshold in a spatial frequency region less than or equal to a first spatial frequency having a spatial frequency value of greater than zero and less than one, and
source-to-source distance of the light sources is optimized by the luminance distribution of the light;
a liquid crystal panel irradiated with light by the illumination device; and
a controller configured to input an image signal to the liquid crystal panel and to input an illumination control signal to the illumination device, the illumination control signal being configured to individually control the light emission luminance of the a plurality of light sources based on the image signal.

12. A liquid crystal display device comprising:
an illumination device including:
a light guide plate including a light emitting surface at which a plurality of grooves extending in a first direction are formed; and
a plurality of light sources whose light emission luminance can be controlled individually, the light sources being configured to supply light from an edge portion of the light guide plate into the light guide plate, the edge portion being perpendicular to the first direction,
a luminance distribution of light injected from the light sources into the light guide plate and emitted from the light emitting surface is obtained by a function such that relative intensity relative to a DC component in a spatial frequency region is less than or equal to a first threshold in a spatial frequency region having a value of one or more, and is greater than or equal to a second threshold in a spatial frequency region less than or equal to a first spatial frequency having a spatial frequency value of greater than zero and less than one, and
source-to-source distance of the light sources is optimized by the luminance distribution of the light;
a liquid crystal panel irradiated with light by the illumination device; and
a controller configured to input an image signal to the liquid crystal panel and to input an illumination control signal to the illumination device, the illumination control signal being configured to individually control the light emission luminance of the a plurality of light sources based on the image signal.
